(19) United States
(12) Patent Application Publication
(10) Pub. No.: US 2026/0057711 A1
(43) Pub. Date: Feb. 26, 2026

(54) VEHICLE DATA MANAGEMENT SYSTEM

(71) Applicant: TOYOTA JIDOSHA KABUSHIKI KAISHA, Toyota-shi (JP)

(72) Inventors: Ryo NEYAMA, Toyota-shi (JP); Masashi NAKAGAWA, Toyota-shi (JP)

(73) Assignee: TOYOTA JIDOSHA KABUSHIKI KAISHA, Toyota-shi (JP)

(21) Appl. No.: 19/097,085

(22) Filed: Apr. 1, 2025

(30) Foreign Application Priority Data
Aug. 26, 2024 (JP) 2024-144332

(51) Int. Cl. G07C 5/00

(52) U.S. Cl. CPC G07C 5/008

(57) ABSTRACT

A vehicle data management system manages, in an external server, data acquired in a vehicle. When first and second events are detected from a plurality of kinds of time-series data, the type of time-series data from which the first event was detected and the type of time-series data from which the second event was detected overlap each other, and a first predetermined period including the first event and a second predetermined period including the second event at least partially overlap each other, the vehicle integrates first data related to the first event and second data related to the second event to generate integrated data, and transmits the integrated data and index data on the integrated data to the server. The server extracts the first and second data from the integrated data based on the index data and provides the first and second data to the user.

### CROSS-REFERENCE TO RELATED APPLICATION

This application claims priority to Japanese Patent Application No. 2024-144332 filed on Aug. 26, 2024. The disclosure of the above-identified application, including the specification, drawings, and claims, is incorporated by reference herein in its entirety.

### BACKGROUND

### 1. Technical Field

The present disclosure relates to the technical field of vehicle data management systems.

### 2. Description of Related Art

For example, the following system has been proposed as this type of system (see Japanese Unexamined Patent Application Publication No. 2022-157157 (JP 2022-157157A)). There is a case where a first upload target event and a second upload target event occur while a vehicle is traveling and there is an overlap period between a period related to the first upload target event and a period related to the second upload target event. In the proposed system, the priority of the first upload target event is compared with the priority of the second upload target event, and data in the overlap period is excluded from a data set related to the upload target event having a lower priority.

### SUMMARY

The technique described in JP 2022-157157 A may increase calculation cost for an external server.

The present disclosure was made in view of the above circumstances, and an object of the present disclosure is to provide a vehicle data management system that can reduce calculation cost.

A vehicle data management system according to an aspect of the present disclosure is a vehicle data management system configured to manage, in a server outside a vehicle, data acquired in the vehicle.

The vehicle includes a processor configured to
detect, as an event, data having a predetermined pattern from a plurality of kinds of time-series data corresponding to a plurality of sensors,
when a first event and a second event are detected from the plurality of kinds of time-series data, acquire first data from the time-series data from which the first event was detected and acquire second data from the time-series data from which the second event was detected, the first data being data for a first predetermined period including the first event, and the second data being data for a second predetermined period including the second event,
when a type of the time-series data from which the first event was detected and a type of the time-series data from which the second event was detected overlap each other and the first predetermined period and the second predetermined period at least partially overlap each other, integrate the first data and the second data to generate integrated data, and transmit the integrated data and index data on the integrated data to the server.

The server includes
an extraction unit configured to, immediately after the integrated data and the index data are received or when there is a request from a user, extract, based on the index data, the first data and the second data from the integrated data, and
a provision unit configured to provide the first data and the second data to the user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing an example of a management system according to an embodiment;

FIG. 2 is a conceptual diagram showing a concept of data processing in a vehicle according to the embodiment;

FIG. 3A is a flowchart showing the operation of the vehicle according to the embodiment;

FIG. 3B is a flowchart showing the operation of the vehicle according to the embodiment;

FIG. 3C is a flowchart showing the operation of the vehicle according to the embodiment;

FIG. 4 is a conceptual diagram showing a concept of data processing in a server according to the embodiment; and

FIG. 5 is a block diagram showing another example of the management system according to the embodiment.

### DETAILED DESCRIPTION OF EMBODIMENTS

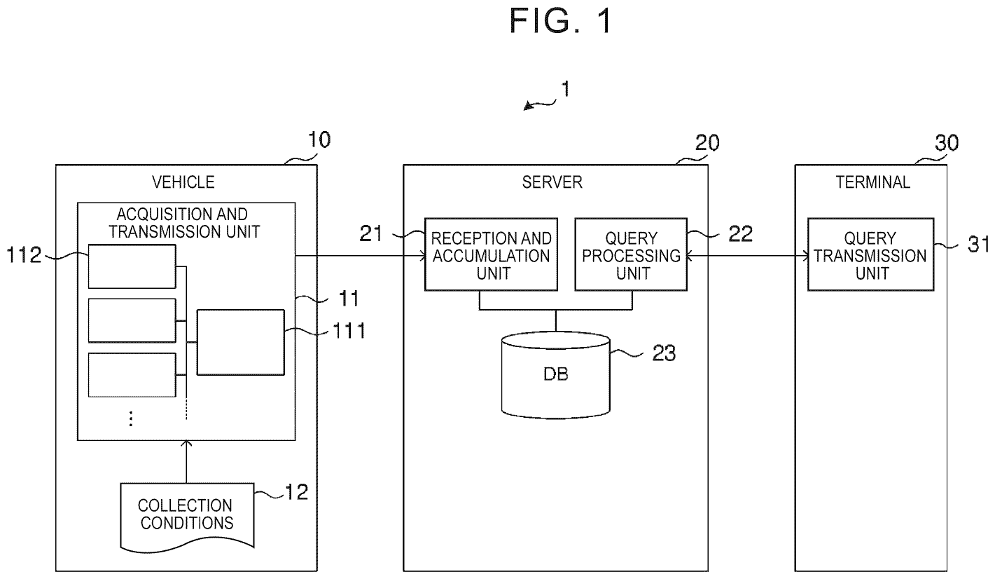

An embodiment of a vehicle data management system will be described with reference to FIGS. 1 to 4. Hereinafter, an embodiment of a vehicle data management system will be described using a management system 1.

In FIG. 1, the management system 1 includes a vehicle 10, a server 20, and a terminal 30. The terminal 30 is a terminal carried by a user. The user may be an end user. The vehicle 10 may be a vehicle owned by the user carrying the terminal 30. However, the vehicle 10 may be a vehicle owned by a person different from the user who carries the terminal 30.

The vehicle 10, the server 20, and the terminal 30 are configured to communicate with each other via a network. The vehicle 10 may be a connected car.

The vehicle 10 includes a plurality of kinds of sensors (not shown). The plurality of kinds of sensors may include an internal sensor and an external sensor. The external sensor may include an image sensor (e.g., a camera). The vehicle 10 includes an acquisition and transmission unit 11. Collection conditions 12 are stored in a memory (not shown) of the vehicle 10. The acquisition and transmission unit 11 includes an event processing unit 111 and a plurality of data input units 112.

Each of the data input units 112 acquires time-series data from an assigned sensor. Since the data input units 112 each acquire time-series data from their assigned sensors, the acquisition and transmission unit 11 acquires a plurality of pieces of time-series data corresponding to the plurality of kinds of sensors.

The data input units 112 will be described. Each of the data input units 112 may include an input interface, a data acquisition unit, and a ring buffer. The time-series data output from the sensor is input to the input interface. The data acquisition unit acquires time-series data input to the input interface. The ring buffer accumulates the time-series data acquired by the data acquisition unit for a certain period of time. That is, in the acquisition and transmission unit 11, the time-series data may be accumulated in the ring buffer for each sensor.

The time-series data acquired by the data acquisition unit is given a time stamp indicating an absolute time. The ring buffer may be configured on a volatile memory or a non-volatile memory. When the ring buffer reaches its upper limit size, the oldest data is overwritten.

The event processing unit 111 may include an event detection and generation unit, an instance buffer, a transmission queue, and an instance transmission unit. The event detection and generation unit detects an event from the time-series data in the ring buffer of the data input unit 112 based on the event detection logic defined in the collection conditions 12. For example, the event detection and generation unit may detect, as an event, data having a predetermined pattern from time-series data in the ring buffer. That is, the acquisition and transmission unit 11 detects an event from the plurality of pieces of time-series data based on the collection conditions 12.

The collection conditions 12 include at least an event type, an event detection logic, a deadline to transmit the detected event to the server 20, and an event period. The “event period” means a period from a time that is a first period before the time when the event occurred to a time that is a second period after the time when the event occurred. The “deadline to transmit the detected event to the server 20” is hereinafter referred to as “deadline” as appropriate.

When an event is detected from the time-series data, the event detection and generation unit identifies data for a predetermined period including the detected event as collection target data, based on the event period defined in the collection conditions 12. The event detection and generation unit stores information on the collection target data as an instance in the instance buffer. At this time, the event detection and generation unit assigns an ID for uniquely identifying the instance to the instance. The instance is meta information, and the collection target data itself is left in the ring buffer.

For example, the ID may be an ID based on a time stamp such as UUIDv7. This configuration facilitates searching for the instance based on the time information. However, the ID is not limited to the ID based on a time stamp such as UUIDv7.

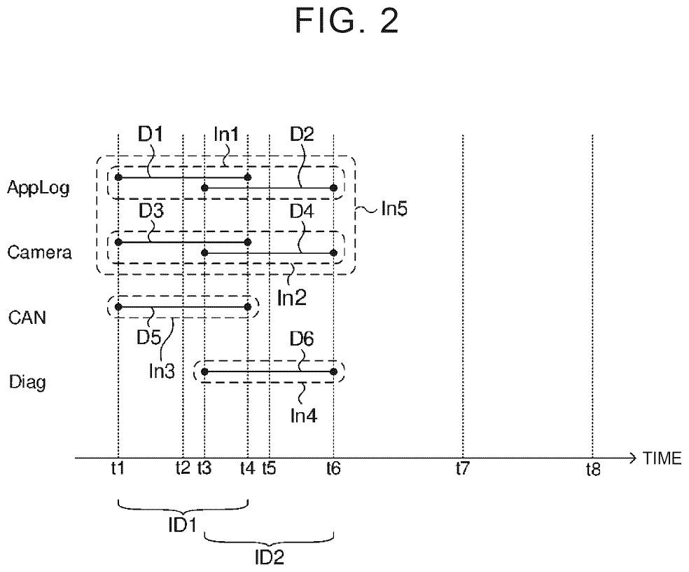

The event processing unit 111 will be described with reference to FIG. 2. In the example shown in FIG. 2, data related to an application log, data related to a camera, data related to a CAN (Controller Area Network), and data related to diagnosis are shown as examples of the plurality of pieces of time-series data corresponding to the plurality of kinds of sensors. In FIG. 2, each continuous line extending along the time axis indicates a period in which data detected as an event (that is, collection target data) is present.

In the example shown in FIG. 2, there are collection target data D1, D2 as collection target data related to the application log (see “AppLog”). There are collection target data D3, D4 as collection target data related to the camera. There is collection target data D5 as collection target data related to the CAN. There is collection target data D6 as collection target data related to the diagnosis (see “Diag”).

In FIG. 2, time t2 is the time when events included in each of the collection target data D1, D3 and D5 are detected. Time t1 is the time that is the first period before time t2 when the events are detected (in other words, the time when the events occur). Time t4 is the time that is the second period after time t2 when the events are detected (in other words, the time when the events occurred). As described above, the first period and the second period are periods related to the event period defined in the collection conditions 12. The first period and the second period may be the same or different.

Time t5 is the time when events included in each of the collection target data D2, D4, and D6 are detected. Time t3 is the time that is the first period before time t5 when the events are detected (in other words, the time when the events occur). Time t6 is the time that is the second period after time t5 when the events are detected (in other words, the time when the events occur).

In the example shown in FIG. 2, for the application log, an instance related to the collection target data D1 and an instance related to the collection target data D2 are stored in the instance buffer. ID1 is assigned as an ID to the instance related to the collection target data D1. ID2 is assigned as an ID to the instance related to the collection target data D2.

For the camera, an instance related to the collection target data D3 and an instance related to the collection target data D4 are stored in the instance buffer. ID1 is assigned as an ID to the instance related to the collection target data D3. ID2 is assigned as an ID to the instance related to the collection target data D4.

For the CAN, an instance In3 related to the collection target data D5 is stored in the instance buffer. ID1 is assigned as an ID to the instance In3. For the diagnosis, an instance In4 related to the collection target data D6 is stored in the instance buffer. ID2 is assigned as an ID to the instance In4.

The instance related to the collection target data includes information on the start time and the end time of the collection target data. The information on the start time and the end time may be information indicating the start time and the end time, or may be pointes (e.g., row numbers or byte offsets) corresponding to the start time and the end time.

The event detection and generation unit integrates two instances including a common kind of data and having an overlap instance period out of a plurality of instances stored in the instance buffer into one virtual instance. The term “kind” may be replaced with “type”.

For example, the collection target data D1, D2 are collection target data related to the application log. Therefore, it can be said that the instance related to the collection target data D1 and the instance related to the collection target data D2 have a common kind of data. Moreover, as shown in FIG. 2, the instance related to the collection target data D1 and the instance related to the collection target data D2 have an overlap period from time t3 to time t4. Therefore, the event detection and generation unit may integrate the instance related to the collection target data D1 and the instance related to the collection target data D2 into one virtual instance In1. The virtual instance In1 is stored in the instance buffer.

The event detection and generation unit sets either the information on the start time included in the instance related to the collection target data D1 or the information on the start time included in the instance related to the collection target data D2, whichever is the information on the start time that is earlier in time, as information on the start time related to the virtual instance In1. The event detection and generation unit sets either the information on the end time included in the instance related to the collection target data D1 or the information on the end time included in the instance related to the collection target data D2, whichever is the information on the end time that is later in time, as information on the end time related to the virtual instance In1. In the example shown in FIG. 2, time t1 is the start time of the virtual instance In1, and time t6 is the end time of the virtual instance In1. The event detecting and generating unit stores, in the virtual instance In1, the IDs (specifically, ID1 and ID2) of the instance related to the collection target data D1 and the instance related to the collection target data D2.

The event detection and generation unit further stores, in the virtual instance In1, data common to the instance related to the collection target data D1 and the instance related to the collection target data D2. The event detection and generation unit deletes the common data from each of the instance related to the collection target data D1 and the instance related to the collection target data D2. As a result, data that is not common to the instance related to the collection target data D1 and the instance related to the collection target data D2 remains in either or both of the instance related to the collection target data D1 and the instance related to the collection target data D2. When there is no non-common data, the event detection and generation unit deletes either or both of the instance related to the collection target data D1 and the instance related to the collection target data D2 from the instance buffer.

For example, the collection target data D3, D4 are collection target data related to the camera. Therefore, it can be said that the instance related to the collection target data D3 and the instance related to the collection target data D4 have a common kind of data. Moreover, as shown in FIG. 2, the instance related to the collection target data D3 and the instance related to the collection target data D4 have an overlap period from time t3 to time t4. Therefore, the event detection and generation unit may integrate the instance related to the collection target data D3 and the instance related to the collection target data D4 into one virtual instance In2. The virtual instance In2 is stored in the instance buffer.

The event detection and generation unit sets either the information on the start time included in the instance related to the collection target data D3 or the information on the start time included in the instance related to the collection target data D4, whichever is the information on the start time earlier in time, as information on the start time related to the virtual instance In2. The event and detection generation unit sets either the information on the end time included in the instance related to the collection target data D3 or the information on the end time included in the instance related to the collection target data D4, whichever is the information on the end time later in time, as information on the end time related to the virtual instance In2. The event detection and generation unit stores, in the virtual instance In2, the IDs (specifically, ID1 and ID2) of the instance related to the collection target data D3 and the instance related to the collection target data D4.

The event detection and generation unit also stores, in the virtual instance In2, data common to the instance related to the collection target data D3 and the instance related to the collection target data D4. The event detection and generation unit deletes the common data from each of the instance related to the collection target data D3 and the instance related to the collection target data D4. As a result, data that is not common to the instance related to the collection target data D3 and the instance related to the collection target data D4 remains in either or both of the instance related to the collection target data D3 and the instance related to the collection target data D4. When there is no non-common data, the event detection and generation unit deletes either or both of the instance related to the collection target data D3 and the instance related to the collection target data D4 from the instance buffer.

For example, it is assumed that there is no kind of data in common with the collection target data D5 related to the CAN. In this case, the event detection and generation unit does not integrate the instance In3 related to the collection target data D5 with any other instances. For example, it is assumed that there is no kind of data in common with the collection target data D6 related to the diagnosis. In this case, the event detection and generation unit does not integrate the instance In4 related to the collection target data D6 with any other instances. The instances In3, In4 may be referred to as real instances.

For example, the data related to the application log and the data related to the camera may be a common kind of data. As shown in FIG. 2, the virtual instance In1 and the virtual instance In2 have an overlap period from time t1 to time t6. Therefore, the event detection and generation unit may integrate the virtual instance In1 and the virtual instance In2 into one virtual instance In5. As described above, the event detection and generation unit repeats the integration process until all instances in the instance buffer that have a common kind of data and have an overlap period are integrated into one virtual instance. Both real instances and virtual instance may be stored in the instance buffer.

The acquisition and transmission unit 11 transmits the instance to the server 20 based on the deadline defined in the collection conditions 12. In the example shown in FIG. 2, the deadline associated with the event detected at time t2 may be time t7. The deadline associated with the event detected at time t5 may be time t8.

For example, the acquisition and transmission unit 11 transmits the instance In3 to the server 20 at time t7. Specifically, in the event processing unit 111, the instance In3 is stored in the transmission queue by time t7. Then, the instance transmission unit of the event processing unit 111 transmits the instance In3 stored in the transmission queue to the server 20 at time t7. Similarly, the acquisition and transmission unit 11 transmits the instance In4 to the server 20 at time t8.

For example, the virtual instance In5 is an instance for both an event detected at time t2 and an event detected at time t5. In the present embodiment, either time t7 or time t8, whichever is earlier, is set as a deadline for the virtual instance In5. That is, time t7 is set as the deadline for the virtual instance In5. Time t7 is a deadline associated with an event detected at time t2. Time t8 is a deadline associated with an event detected at time t5. Therefore, the acquisition and transmission unit 11 transmits the virtual instance In5 to the server 20 at time t7.

When transmitting an instance to the server 20, the acquisition and transmission unit 11 transmits, in addition to the instance, data in the ring buffer referred to by the instance and an index associated with the instance to the server 20. The data in the ring buffer referred to by the instance is, that is, data corresponding to the acquisition target data. When the instance is a real instance, the index includes an ID of the real instance and a time period of the real instance (e.g., information on the start time and the end time). When the instance is a virtual instance, the index includes an ID of the virtual instance, and an ID and time period of the instance referred to by the virtual instance (in other words, the integrated instance).

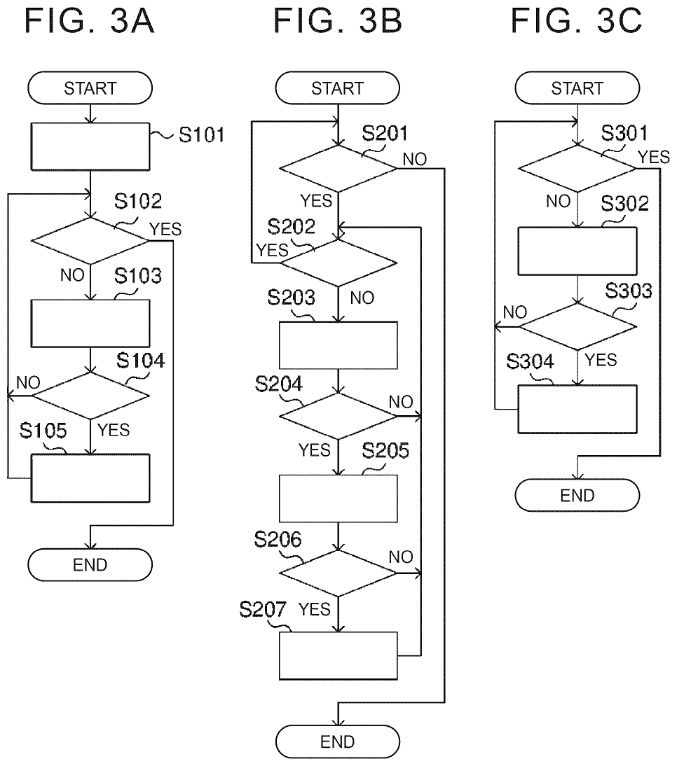

Next, an event detection process that is performed by the event detection and acquisition unit of the event processing unit 111 will be described with reference to the flowchart of FIG. 3A. In FIG. 3A, the event detection processing unit reads new data from the ring buffer (S101). Next, the event detection processing unit determines whether the process of detecting all the triggers has been completed (S102). In S102, when it is determined that the process of detecting all the triggers has been completed (S102: Yes), the process ends.

When it is determined in S102 that the process of detecting all the triggers has not been completed (S102: No), the event detection and acquisition unit confirms that an event has occurred by the logic of the trigger (S103). Next, the event detection and acquisition unit determines whether an event has been detected (S104). When it is determined in S104 that an event has not been detected (S104: No), the event detection and acquisition unit performs S102.

When it is determined in S104 that an event has been detected (S104: Yes), the event detection and acquisition unit generates an instance and stores it in the instance buffer (S105). The process then proceeds to S102.

Next, an instance integration process that is performed by the event-detection acquiring unit will be described with reference to FIG. 3B. In FIG. 3B, the event detection and acquisition unit determines whether none of the instances in the instance buffer can be integrated (S201). When it is determined in S201 that none of the instances can be integrated (S201: No), the process ends.

When it is determined in S201 that any of the instances can be integrated (S201: Yes), the event detection and acquisition unit determines whether combinations of all the instances in the instance buffer have been checked (S202). When it is determined in S202 that all the combinations of the instances have been checked (S202: Yes), the event detection and acquisition unit performs S201.

When it is determined in S202 that not all the combinations of the instances have been checked (S202: No), the event detection and acquisition unit extracts the subsequent combination of the instances (S203). Next, the event detection and acquisition unit determines whether the two instances have a common kind of data as a collection target and have an overlap period (S204).

When it is determined in S204 that the two instances do not have a common kind of data as a collection target or do not have any overlap period (S204: No), the event detection and acquisition unit performs S202. On the other hand, when it is determined in S204 that the two instances have a common kind of data as a collection target and have an overlap period (S204: Yes), the event detection and acquisition unit performs S205. That is, the event detection and acquisition unit generates one virtual instance (S205). At this time, the event detection and acquisition unit collects the common kind of data of the two instances. The event detection and acquisition unit sets one of the start times of the two instances, whichever is earlier, and one of the end times of the two instances, whichever is later, as the start time and the end time of the virtual instance. The event detection and acquisition unit sets one of the deadlines for the two instances, whichever is earlier, as the deadline for the virtual instance. The event detection and acquisition unit adds the virtual instance to the instance buffer. The event detection and acquisition unit leaves only the data collection target of the non-common kind in the two instances.

Next, the event detection and acquisition unit determines whether the remaining collection target of the two instances is an empty set (S206). When it is determined in S206 that the remaining collection target is an empty set (S206: Yes), the event detection and acquisition unit deletes an instance whose remaining collection target is an empty set from the instance buffer (S207). The process then proceeds to S202. When it is determined in S206 that the remaining collection target is not an empty set (S206: No), the event detection and acquisition unit performs S202.

Next, a deadline process that is performed by the event processing unit 111 will be described with reference to the flowchart of FIG. 3C. In FIG. 3C, the event processing unit 111 determines whether the deadlines for all the instances in the instance buffer have been checked (S301). When it is determined in S301 that all the deadlines for the instances have been checked (S301: Yes), the process ends.

When it is determined in S301 that not all of the deadlines for the instances have been checked (S301: No), the event processing unit 111 extracts the subsequent instance from the instance buffer (S302). Next, the event processing unit 111 determines whether the deadline for the instance is the current time or later (S303).

When it is determined in S303 that the deadline for the instance is the current time or later (S303: Yes), the event processing unit 111 performs S304. That is, the event processing unit 111 retrieves data referred to by the instance from the ring buffer, gives an index to the data, and stores the data in the transmission queue (S304). Thereafter, the event processing unit 111 performs S301. On the other hand, when it is determined in S303 that the deadline for the instance is not the current time or later (S303: No), the event processing unit 111 performs S301.

Referring back to FIG. 1, the reception and accumulation unit 21 of the server 20 stores the instance and index received from the vehicle 10 in the database 23. At this time, the reception and accumulation unit 21 transmits the reception acknowledgement to the vehicle 10.

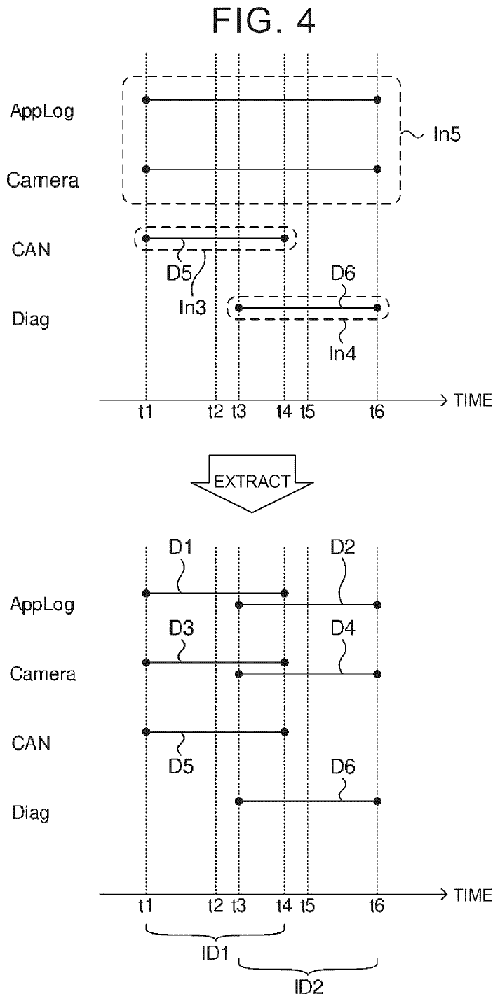

For example, the reception and accumulation unit 21 may extract the original instance (i.e., the real instance) from the virtual instance immediately after receiving the virtual instance and the index. A method for extracting an original instance will be described with reference to FIG. 4. In FIG. 4, the same portions as those in FIG. 2 are denoted by the same signs.

It is herein assumed that the index of the virtual instance In5 includes start time t1 and end time t4 for ID1 and start time t3 and end time t6 for ID2.

The reception and accumulation unit 21 may extract, from the virtual instance In5, an instance related to the collection target data D1 of the application log based on start time t1 and end time t4 for ID1 included in the index. The reception and accumulation unit 21 may extract, from the virtual instance In5, an instance related to the collection target data D3 of the camera based on start time t1 and end time t4 for ID1 included in the index. The reception and accumulation unit 21 may extract, from the virtual instance In5, an instance related to the collection target data D2 of the application log based on start time t3 and end time t6 for ID2 included in the index. The reception and accumulation unit 21 may extract, from the virtual instance In5, an instance related to the collection target data D4 for the camera based on start time t3 and end time t6 for ID2 included in the index. As a result, a real instance may be extracted as shown in the lower part of FIG. 4.

When the start time and the end time are used to extract the original instance, the cost is O(logN) to O(N). For example, when the row number or the byte offset from the head of the data of the virtual instance is used to extract the original instance, the cost is O(1).

Referring back to FIG. 1, the query transmission unit 31 of the terminal 30 transmits an instance request from the user as a query to the query processing unit 22 of the server 20. The query may include acquiring all instances, acquiring instances with matching ID prefixes, acquiring instances with specific IDs, acquiring instances with specific event types, or a combination thereof. The query may include, as a filter condition, part or all of ID or VIN (vehicle identification number) for identifying the collection conditions and the event type.

When the server 20 receives a query from the terminal 30, the query processing unit 22 of the server 20 transmits the original instance requested by the query to the terminal 30 (that is, provides the original instance to the user).

Note that extraction of the original instance does not necessarily have to be performed immediately after the virtual instance and the index are received. For example, the original instance may be extracted from the deadline identified from the instance and collection conditions that the server 20 initially received after a sufficient time has elapsed before all virtual instances are sent to the server 20. Transmission to the server 20 is, in other words, an upload. For example, the original instance may be extracted when the server 20 receives a query from the terminal 30 (in other words, when there is a request from a user).

### Technical Effects

In the management system 1, as described above, overlapping data is integrated by creating a virtual instance. Therefore, the management system 1 can avoid overlapping data (that is, the same data) being transmitted from the vehicle 10 to the server 20 a plurality of times. As a result, the communication cost and the server operation cost can be reduced. In addition, since the deadline is set for each instance in the management system 1, it is possible to guarantee that the instance is transmitted to the server 20 when the deadline is reached even when an event occurs continuously. As a result, in the vehicle 10, it is possible to avoid that the instances continue to be unified without limit. Therefore, according to the management system 1, it is possible to suppress the calculation cost and reduce the amount of communication data.

### First Modification

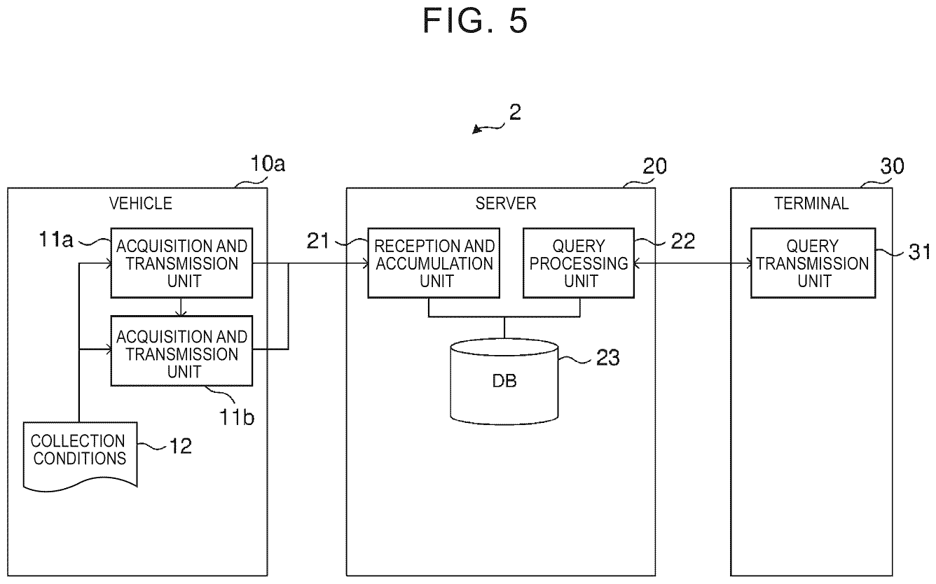

A first modification of the vehicle data management system will be described with reference to FIG. 5. The first modification of the vehicle data management system will be described below with reference to a management system 2. In FIG. 5, the management system 2 includes a vehicle 10a, a server 20, and a terminal 30. The vehicle 10a includes acquisition and transmission units 11a, 11b.

After the acquisition and transmission unit 11a detects an event from one piece of data, the acquisition and transmission unit 11a may request the acquisition and transmission unit 11b to acquire and transmit another piece of data. At this time, the acquisition and transmission unit 11a may transmit, to the acquisition and transmission unit 11b, information indicating ID, the event type, and the target kind of data in order to cause the acquisition and transmission unit 11b to identify other data. The acquisition and transmission unit 11b may generate an instance based on the information transmitted from the acquisition and transmission unit 11a and the collection conditions 12. The acquisition and transmission unit 11b may transmit the instance to the server 20.

### Second Modification

In the instance integration process described with reference to the flowchart of FIG. 3B, since the combinations of all the instances in the instance buffer is checked, the calculation cost is O(N²). Therefore, in the instance integration process, the instances in the instance buffer may be sorted in the chronological order of the start time and the end time. Then, the sorted instances are integrated in the chronological order, so that the instance integration processing can be efficiently performed. The computation cost for the sorting is O(logN), and the computation cost for the subsequent processes is O(N). That is, in the second modification, the instance-integration process can be performed at the computation cost of O(NlogN).

### Third Modification

In the example shown in FIG. 2, the period from the collection target data D1 to D6 (that is, the period from the start time to the end time) is the same. However, it may be desirable to have different time periods for events for one sensor defined in the collection conditions 12 and for other sensors. In the example shown in FIG. 2, the data for the CAN may be collected for a longer time than the other data. In this case, the acquisition and transmission unit 11 may transmit, to the server 20, an instance (for example, a virtual instance) divided for each predetermined period shorter than the collection period for CAN. In this case, the acquisition and transmission unit 11 may add the start time and the end time of each divided instance to the index related to the divided instance.

For example, the index for the first split instance may include a start time and an end time of the first split instance. After the first split instance, the index for the second split instance sent to the server 20 may include a start time and an end time of the first split instance and a start time and an end time of the second split instance. The index for the third split instance may include a start time and an end time of the first split instance, a start time and an end time of the second split instance, and a start time and an end time of the third split instance. The third split instance is sent to the server 20 after the second split instance.

Aspects of the disclosure derived from the above embodiments and modifications are described below.

A vehicle data management system according to an aspect of the present disclosure is a vehicle data management system that manages data acquired in a vehicle in a server outside the vehicle. The vehicle includes a processor. The processor is configured to detect, as an event, data having a predetermined pattern from a plurality of kinds of time-series data corresponding to the plurality of sensors. The first event and the second event may be detected from the plurality of kinds of time-series data. In this case, the processor is configured to acquire the first data from the time-series data in which the first event is detected, and acquire the second data from the time-series data in which the second event is detected. The first data is data of a first predetermined period including the first event. The second data is data of a second predetermined period including the second event. There is a case where the type of the time-series data in which the first event is detected and the type of the time-series data in which the second event is detected overlap each other, and the first predetermined period and the second predetermined period at least partially overlap each other. In this case, the processor is configured to integrate the first data and the second data to generate integrated data. The processor is configured to transmit the integrated data and index data relating to the integrated data to the server. The server includes an extraction unit and a provision unit. Immediately after receiving the integrated data and the index data, the extraction unit extracts the first data and the second data from the integrated data based on the index data. Alternatively, when there is a request from the user, the extraction unit extracts the first data and the second data from the integrated data based on the index data. The provision unit provides the first data and the second data to the user.

In the above embodiment, the “acquisition and transmission unit 11” is an example of the “processor”, the “reception and accumulation unit 21” is an example of the “extraction unit”, and the “query processing unit 22” is an example of the “provision unit”.

In the vehicle data management system, the index data may include first information regarding a start time and an end time of the first data, and second information regarding a start time and an end time of the second data.

In the vehicle data management system, the processor sets a first timing to transmit the first data to the server based on the first predetermined period and a second timing to transmit the second data to the server based on the second predetermined period; and The timing at which the integrated data is transmitted to the server may be an earlier timing among the first timing and the second timing.

The present disclosure is not limited to the above embodiments, and can be modified as appropriate within the scope and spirit of the disclosure that can be read from the claims and the entire specification. Vehicle data management systems with such changes are also within the scope of the present disclosure.

What is claimed is:

1. A vehicle data management system configured to manage, in a server outside a vehicle, data acquired in the vehicle, wherein:
the vehicle includes a processor configured to
detect, as an event, data having a predetermined pattern from a plurality of kinds of time-series data corresponding to a plurality of sensors,
when a first event and a second event are detected from the plurality of kinds of time-series data, acquire first data from the time-series data from which the first event was detected and acquire second data from the time-series data from which the second event was detected, the first data being data for a first predetermined period including the first event, and the second data being data for a second predetermined period including the second event,
when a type of the time-series data from which the first event was detected and a type of the time-series data from which the second event was detected overlap each other and the first predetermined period and the second predetermined period at least partially overlap each other, integrate the first data and the second data to generate integrated data, and
transmit the integrated data and index data on the integrated data to the server; and
the server includes
an extraction unit configured to, immediately after the integrated data and the index data are received or when there is a request from a user, extract, based on the index data, the first data and the second data from the integrated data, and
a provision unit configured to provide the first data and the second data to the user.

2. The vehicle data management system according to claim 1, wherein the index data includes first information on a start time and an end time of the first data and second information on a start time and an end time of the second data.

3. The vehicle data management system according to claim 1, wherein:
the processor is configured to set a first timing to transmit the first data to the server based on the first predetermined period and a second timing to transmit the second data to the server based on the second predetermined period; and
a timing to transmit the integrated data to the server is either the first timing or the second timing, whichever is earlier.
